(19) United States
(12) Patent Application Publication
(10) Pub. No.: US 2013/0099038 A1
(43) Pub. Date: Apr. 25, 2013

(54) JAW CRUSHER

(71) Applicants: Stefan Hartl, Au/Donau (AT); Paul Voithofer, Steyr (AT)

(72) Inventors: Stefan Hartl, Au/Donau (AT); Paul Voithofer, Steyr (AT)

(21) Appl. No.: 13/699,765

(22) PCT Filed: Mar. 11, 2011
(86) PCT No.: PCT/AT2011/000126

§ 371 Date: Dec. 19, 2012

(30) Foreign Application Priority Data
Mar. 11, 2010 (AT) A 391/2010

(51) Int. Cl. B02C 1/04

(52) U.S. Cl. CPC B02C 1/04
USPC 241/264

(57) ABSTRACT

A jaw crusher is described, comprising a crushing chamber (2) between a fixed jaw (3) and a swing jaw (4), and an eccentric drive (7) for the swing jaw (4) which is supported at the end of the swing jaw opposite the eccentric drive (7) on a rocker plate (8) whose counter-bearing (10) arranged as a cross-member (9) is supported on its part on a hydraulic overload protection mechanism (12). In order to provide advantageous constructional conditions it is proposed that the cross-member (9) which forms the counter-bearing (10) for the rocker plate (8) is retained in lateral rocker arms (11) held coaxially to the eccentric shaft (6) of the eccentric drive (7), with the lever axis (15) of the rocker plate (8) enclosing an acute angle α with a radial line (16) to the eccentric shaft (6) passing through the counter-bearing (10) of the rocker plate in a projection in the direction of the eccentric shaft (6).

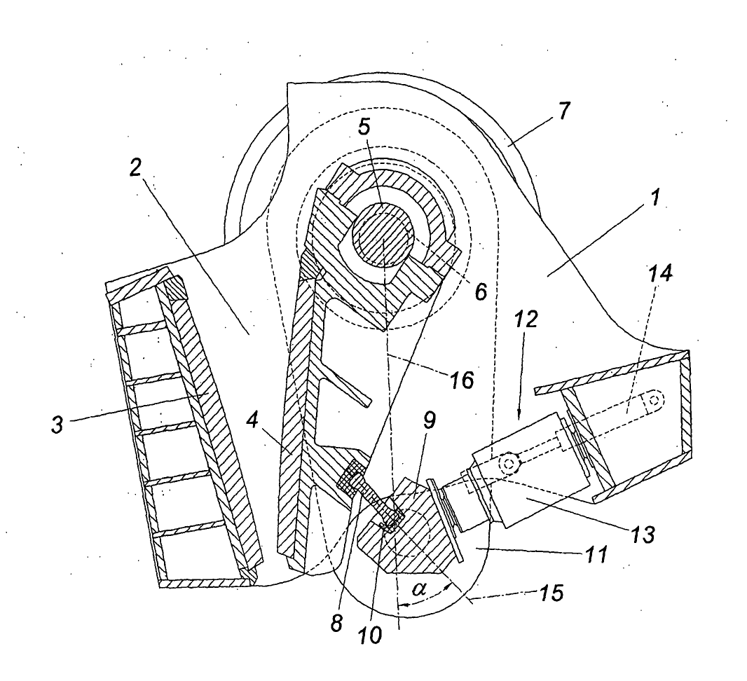

### FIELD OF THE INVENTION

The invention relates to a jaw crusher, comprising a crushing chamber between a fixed jaw and a swing jaw, and comprising an eccentric drive for the swing jaw which is supported at the end of the swing jaw opposite the eccentric drive on a rocker plate whose counter-bearing arranged as a cross-member is supported on its part on a hydraulic overload protection mechanism.

### DESCRIPTION OF THE PRIOR ART

In order to protect a jaw crusher from overload by unbreakable material it is known (EP 1 494 810 A1) to support the swing jaw, which is opposite of the fixed jaw of the crushing chamber and is driven by means of an eccentric drive, via a rocker plate on a cross-member on the jaw end opposite of the eccentric drive, which cross-member forms a counter-bearing for the rocker plate and is held in its working position by a hydraulic overload protection mechanism. Said overload protection mechanism, which is arranged of two cylinder-piston units which support the cross-member against displacement in the manner of an expansion of the crushing gap, will respond when the hydraulic pressure in the cylinder piston units exceeds an upper threshold value, so that the cross-member is able to displace the pistons by displacement of the hydraulic medium in the cylinders. It is disadvantageous in these known jaw crushers for example that the effective crushing forces need to be dissipated by the cylinder-piston units of the overload protection mechanism onto the frame of the jaw crusher, which places special constructional demands on the overload protection mechanism. It is further difficult to newly set the crushing gap between the fixed jaw and the swing jaw after a response of the overload protection mechanism.

### SUMMARY OF THE INVENTION

The invention is therefore based on the object of arranging a jaw crusher of the kind mentioned above in such a way that an overload protection mechanism can be ensured which is effective without any limits and without requiring the build-up of the full supporting forces for the swing jaw via the overload protection mechanism.

This object is achieved in accordance with the invention such a way that the cross-member which forms the counter-bearing for the rocker plate is retained in lateral rocker arms held coaxially to the eccentric shaft of the eccentric drive, with the lever axis of the rocker plate enclosing an acute angle with a radial line to the eccentric shaft passing through the counter-bearing of the rocker plate in a projection in the direction of the eccentric shaft.

As a result of these measures, a force is obtained via the rocker plate on its cross-member forming the count-bearing, which force which has a force component which is radial with respect to the eccentric shaft depending on the angular position of the rocker plate in relation to the rocker arms accommodating the cross-member, so that a partial load corresponding to said force component is absorbed via the rocker arms to the eccentric shaft and therefore to the frame of the jaw crusher. This means that it is merely necessary to support the torque exerted on the rocker arms in relation to the frame via the hydraulic overload protection mechanism. Since this torque only originates from one force component which is disposed perpendicularly to the force component of the crushing forces to be absorbed, which force component is radial to the eccentric shaft, the overload protection mechanism is subjected to respectively low forces, which inevitably provides advantageous constructional conditions for the overload protection mechanism.

The arrangement of the cross-member in lateral rocker arms, which cross-member forms a counter-bearing for the rocker plate, further offers advantageous constructional preconditions for setting the crushing gap after triggering the overload protection mechanism, because the crushing gap can be reset in a simple manner by means of a hydraulic actuating drive for the rocker arms. It is obvious that said actuating drive must not obstruct the overload protection mechanism. Accordingly, said actuating drive will only be subjected to the pressure medium when a respective setting of the crushing gap is required. The support of the swing jaw in the preset crushing gap occurs via the rocker plate and the cross-member by means of the overload protection mechanism.

### BRIEF DESCRIPTION OF THE DRAWING

The subject matter of the invention is shown in the drawing by way of example, which shows a jaw crusher in accordance with the invention in a schematic longitudinal sectional view.

### DESCRIPTION OF THE PREFERRED EMBODIMENT

The illustrated jaw crusher comprises a frame 1 which forms a crushing chamber 2 between a jaw 3 fixed to the frame and a swing jaw 4. Said swing jaw 4, which forms a crushing gap which tapers with the fixed jaw 3 in the direction of the throughput of the crushing material, is held on the eccentric 5 of the eccentric shaft 6 of an eccentric drive 7 and is supported on a rocker plate 8 at its end opposite of the eccentric drive 7, which rocker plate has its counter-bearing 10 in a cross-member 9. Said cross-member 9 is held in lateral rocker arms 11 which are rotatably mounted on the eccentric shaft 6 of the eccentric drive 7. A hydraulic overload protection mechanism 12 is used for the torque support of the rocker arms 11 in relation to the frame 1, which overload protection mechanism comprises at least one cylinder-piston unit 13 and is supported according to the illustrated embodiment on the cross-member 9, which is not mandatory however because the overload protection mechanism 12 can also act on the rocker arms 11. Once the pressure in the hydraulic cushion which supports the piston in the cylinder-piston unit 13 exceeds an upper threshold value, a safety valve will open so that the cross-member 9 can be displaced under pivoting of the rocker arms 11 within the terms of an expansion of the crushing gap between the two jaws 3, 4.

In order to enable setting the originally set crushing gap again after actuation of the overload protection mechanism 12, an actuating cylinder 14 is provided between the frame 1 and at least one of the two rocker arms 11, which will pivot back the rocker arms 11 to the initial position upon being subjected to a pressure medium, so that the cylinder-piston unit 13 can be blocked again in this position by the safety valve.

As is shown in the drawing, the lever axis 15 of the rocker plate 8 extends in a projection in the direction of the eccentric shaft 6 under an acute angle α in relation to a radial line 16 to the eccentric shaft 6, which radial line passes through the counter-bearing 10. This means that the crushing forces acting in the direction of the lever axis 15 on the cross-member 9 and therefore on the rocker arms 11 have a force component which is radial to the eccentric shaft 6 and a force component which is perpendicularly thereto, which per se determines the torque load of the rocker arms 11, so that it is merely necessary to support said torque load via the overload protection mechanism 12 in relation to the frame 1. The partial load determined by the radial force component will be absorbed directly via the rocker arms 11 and their bearing onto the frame 1. This means that relatively low supporting forces can be expected for the overload protection mechanism 12, which enables simple constructional conditions for the overload protection mechanism 12.

1. A jaw crusher, comprising a crushing chamber (2) between a fixed jaw (3) and a swing jaw (4), and an eccentric drive (7) for the swing jaw (4) which is supported at the end of the swing jaw opposite the eccentric drive (7) on a rocker plate (8) whose counter-bearing (10) arranged as a cross-member (9) is supported on its part on a hydraulic overload protection mechanism (12), wherein the cross-member (9) which forms the counter-bearing (10) for the rocker plate (8) is retained in lateral rocker arms (11) held coaxially to the eccentric shaft (6) of the eccentric drive (7), with the lever axis (15) of the rocker plate (8) enclosing an acute angle α with a radial line (16) to the eccentric shaft (6) passing through the counter-bearing (10) of the rocker plate in a projection in the direction of the eccentric shaft (6).

2. A jaw crusher according to claim 1, wherein the crushing gap is adjustable by means of a hydraulic actuating drive (14) for the rocker arms (11).
